(19) United States
(12) Patent Application Publication
(10) Pub. No.: US 2006/0150513 A1
(43) Pub. Date: Jul. 13, 2006

(54) Inlet brake for the rear opening hood of a motor vehicle and rear opening hood opening device of a motor vehicle

(75) Inventor: Thomas Kleeh, Rangendingen (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 10/532,490

(22) PCT Filed: Sep. 30, 2003
(86) PCT No.: PCT/EP03/10819

§ 371 Date: Dec. 9, 2005

(30) Foreign Application Priority Data
Oct. 24, 2002 (DE) 10249468.1

(51) Int. Cl. E05F 15/02

(52) U.S. Cl. 49/340

(57) ABSTRACT

A catch brake for a trunk lid of a motor vehicle is proposed, as well as a trunk lid opening system for slowing the opening movement of the trunk lid upon reaching its open position, a tubular hinge bail (3) of the trunk lid being braked in a substantially U-shaped receiver (4) by a clamping action and prevented from rebounding, the receiver (4) being provided with tapering lateral brake cheeks (5) with a continuous taper in the direction of the opening movement, so that a narrowing clamping receiver is formed.

### BACKGROUND AND SUMMARY OF THE INVENTION

The invention relates to a catch brake for a trunk lid of a motor vehicle with which the opening movement of the trunk lid is slowed and any rebounding thereof can be prevented. The invention likewise relates to a trunk lid opening system of a motor vehicle, preferably an automatic trunk lid opening system of a motor vehicle, preferably an automatic trunk lid opening system having a catch brake for slowing and holding the trunk lid in its open position.

It is known in motor vehicle technology to slow the opening movement of a trunk lid of the motor vehicle, which is brought about, for example, by tension springs or an automatic actuation, just before the trunk lid reaches its open position. It is also known to provide means which prevent any rebounding of the trunk lid. Thus a stable open position of the trunk lid can be achieved. The slowing of the opening movement is necessary in order to avoid any snapping back or bouncing back of the trunk lid. For this purpose it is known to provide on the vehicle an element of substantially U-shape having lateral braking lobes.

A catch brake of this kind for a trunk lid is represented in a plan view in FIGS. 1 and 2. The lateral lobes 5 of the catch brake are for this purpose formed with a projecting catch section. The hinge tube 3 of the trunk lid is shaped for this purpose with a projecting clasp section such that the hinge tube 3 of the trunk lid is first slowed down and then clutched by the projecting catch sections in its end position shown in FIG. 2. The lateral brake cheeks 5 of this catch brake are joined together by a connecting section 6, which has fastening means such as a mounting screw 2. The connection section 6 is provided with projecting fingers 7 which are intended to prevent the hinge tube 3 and with it the trunk lid of the vehicle from bouncing back. It has been found, however, that despite the fingers 7 the bouncing back of the trunk lid does occur. Also, it has proven disadvantageous in this kind of trunk lid catch brake 1 that the projecting sections of the lateral brake cheeks 5 are subject to great wear and due to attrition of its metal the catch brake 1 is relatively quickly impaired in its operation and effectiveness. Moreover, the operation of the brake is greatly impaired by the ambient temperature. When it is warm the trunk lid is not held back, and when it is cold it collides outside with the brake.

The problem on which the present invention is based is to offer an catch brake for a motor vehicle as well as a trunk lid opening device with such an catch brake, which provides a slowing of the opening movement and likewise the prevention of recoil, and does so with the same reliability and effectiveness over a long period of time and wider temperature range.

This problem is solved with a catch brake for a trunk lid of a motor vehicle for slowing an opening movement of the trunk lid upon reaching its open position. The catch brake includes a narrowing U-shaped clamping receiver for braking a tubular hinge bail of the trunk lid with a clamping action and to prevent the trunk lid from rebounding. The clamping receiver includes tapering lateral brake cheeks and a resiliently deformable. The brake cheeks form a continuous taper in the direction of the opening motion of the trunk lid, and are elastically flexible to one another. The resiliently deformable connecting link joining the lateral brake cheeks together, wherein the resiliently deformable. This problem is also solved with a trunk lid opening device of a motor vehicle for moving a trunk lid from a closed position to an open position. The opening device includes the above catch brake.

According to the invention, the catch brake, which includes a substantially U-shaped receiver in which a tubular hinge ring can be clamped and thereby braked to a stop. The catch brake has lateral brake cheeks which form a continuous taper in the direction of the opening movement. The tapering thus formed in the receiving area between the two brake cheeks is thus likewise uniform. A substantially V-shaped clutching gap for the tube of the hinge ring of a trunk lid is presented. Due to the continuous taper, with increasing penetration of the tube of the hinge ring into the brake, the gripping force which is produced by the lateral brake cheeks is steadily augmented. The braking of the opening movement is thus also continuous. Also, the increasing gripping force also produces an increasing retention force on the hinge ring without the need to provide protruding retention sections or hook-like means. The continuously increasing gripping force on the holding tube of the hinge ring also brings it about that any bounding back of the trunk lid due to collision with an end section in the catch brake is effectively prevented. In fact, it has developed surprisingly that the nubs provided on the middle section of the socket of the catch brake, which are provided in the state of the art (see FIGS. 1 and 2), produce a contrary action in regard to the recoil, namely they actually promote such recoil rather then prevent it. According to the invention, therefore, the lateral brake cheeks are matched to one another and in their tapering or narrowing toward the open position they are so coordinated with the hinge ring of the trunk cover that any head-on collision or recoiling effect is prevented.

In an advantageous embodiment of the invention, the brake cheeks are arranged resiliently to one another. The resilience can be achieved either through the choice of the material of the yoke of the catch brake or through the choice of the material and shape of the brake cheeks themselves. The resilient action results in an improved gripping force and retaining force, so that even in the case of accidentally or deliberately slamming down of the trunk lid, the tube of the hinge ring and thus the trunk lid itself is held in the catch brake. The resilient design of the brake cheeks toward one another also permits an adjustment of the increase of the gripping action and thus a more or less strong braking action (more or less abrupt).

In an additional advantageous embodiment of the invention, the brake cheeks are so configured that a continuously tapering clamping receiver is formed into which the hinge ring can enter without front-end collision. Any recoil is thus reliably and effectively prevented.

In an additional advantageous embodiment of the invention, the lateral brake cheeks of the catch brake are joined together by a resiliently deformable back which has a fastening means. The catch brake can thus be fastened on the body of the vehicle. Due to the deformable back section additional clamping force can be produced between the brake cheeks.

In an additional advantageous embodiment of the invention, the brake cheeks are made from a hard plastic material that is resistant to attrition. Premature wear is thus prevented, and thus any impairment of the operation of the catch brake is avoided. It has been found that protruding sections such as were known in catch brakes of the state of the art were relatively quickly rendered inoperative due to wear when synthetic materials were used. Preferably, therefore, a thermoplastic is chosen for the brake cheeks of the catch brake, such as a polyoxymethylene (POM), for example, which is characterized by good formability and high resistance to abrasion and a slick surface. According to an aspect of the invention in this connection, the catch brake is formed from a multi-component plastic part, wherein the back of the device is made from a softer plastic than the lateral brake cheeks. Also preferably, the lateral brake cheeks are formed from a relatively hard core of a plastic material which is embedded by injection in a softer plastic material. In this manner the properties of high resistance to attrition can be combined with an additional braking action on the basis of a soft and thus movement-slowing material.

The trunk lid opening device according to the invention, with an catch brake for braking and for the retention of the trunk lid in an open position according to an embodiment of the invention is characterized in that the catch brake has lateral brake cheeks with continuous tapering between them. A continuous taper in the sense of a steadily narrowing or tapering accommodation in the direction of the opening position has the advantage that especially a cylindrical mounting tube of a hinge loop, upon reaching or engaging the open position is increasingly gripped between the brake cheeks and held effectively against rebounding.

In an advantageous embodiment, the trunk lid opening device is an automatic opening device. In particular, in the automatic opening of a trunk lid, in which the driver or operator is not necessarily in the vicinity of the trunk lid, the problem is that a trunk lid jumps up on account of the tension springs conventionally used and does not remain in its open position, i.e., its end position. The trunk lid can collide with an end stop and bounce back, and not until after a few fluttering movements does it assume a stable position. With the trunk lid opening device according to the invention, it is assured that a stable end position in the open state is achieved immediately and without delay.

### BRIEF DESCRIPTION OF THE DRAWINGS

Two embodiments of the invention are described in greater detail hereinafter with reference to the appended drawing. In the drawing,

FIGS. 1 and 2 show an catch brake of a motor vehicle trunk lid in the state of the art in a plan view in a position before reaching the open position and in the opening position, respectively.

FIG. 3 is a schematic plan view of an embodiment of the invention with a cylindrical holding bail of the trunk lid in its open position.

FIG. 4 is a view similar to FIG. 3 of an embodiment of an catch brake of the invention indicating the increase of the holding force.

FIG. 5 is a schematic perspective view of a second embodiment of an catch brake for a motor vehicle trunk lid, including a multiple-component piece.

### DETAILED DESCRIPTION OF THE DRAWINGS

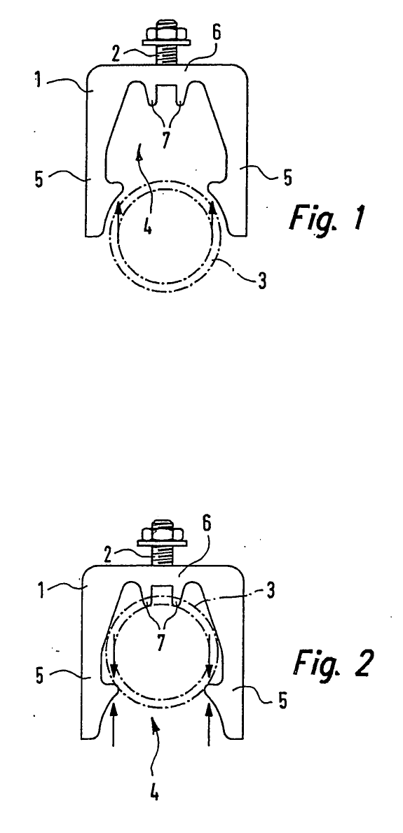

In FIGS. 1 and 2, different positions are shown of a bail 3 upon entering an catch brake 1 of the state of the art. To prevent rebound and to brake the movement of the trunk lid, the known catch brake 1 has on the brake cheeks 5 sections that reach inward into the receiver 4, and two nubs 7 on the back end of the receiver 4, by means of which an attempt was made to prevent rebounding. It has been found, however, that the nubs 7 produce instead a strong rebounding of the trunk lid and thus they are ineffective. Also, it has been found in these known catch brakes that great wear on the protruding sections of the brake cheeks 5 leads to premature failure of the catch brake. Furthermore, it has been found disadvantageous in these catch brakes that they are very temperature-dependent. At high temperatures, the braking action by the brake cheeks was so little that no effective braking was possible. At too low temperatures, however, the brake cheeks were so hard that the hinge bail did not enter at all into the receiver 4 and was pushed away by the protruding sections of the brake cheeks 5.

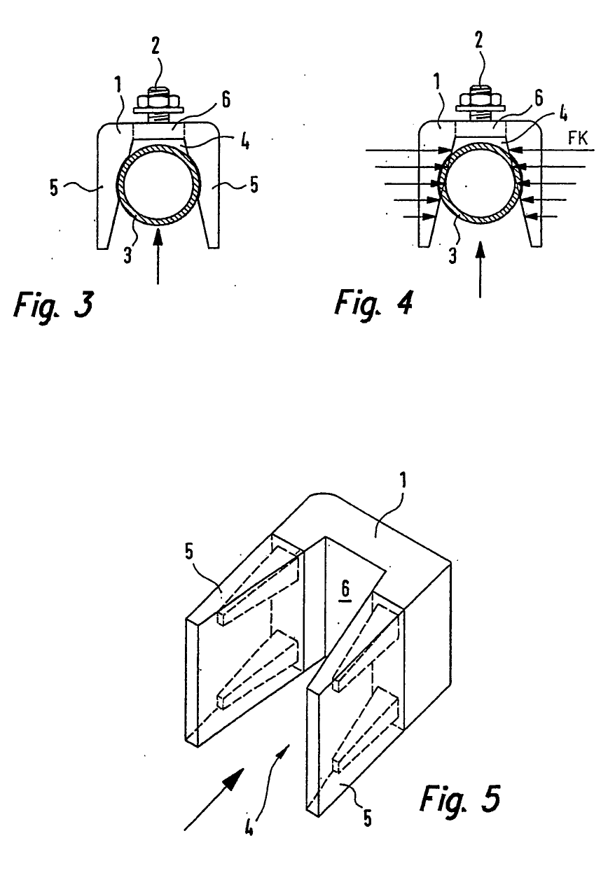

In FIGS. 3 and 4, there is shown schematically in plan views a first embodiment of a catch brake 1 for a trunk lid of a motor vehicle. A cylindrical bail 3 of a hinge lever of a trunk lid (not shown) of a motor vehicle is braked upon entering the receiver 4. The slanting inside of the brake cheeks 5 forms an increasing narrowing or tapering in the direction of the end position, that is, the open position of the trunk lid, so that, as indicated by force arrows in FIG. 4, an increasing gripping force is exerted on the bail 3. The gripping force results on the one hand in a gentle retardation of the opening movement of the trunk lid, and on the other hand any rebounding or unintended slipping out is prevented by the gripping. As a result, a stable open position of the trunk lid is achieved. The shape of the catch brake is quite simple, offering advantages in manufacture.

The continuous taper has the advantage furthermore that failure of the brake due to premature wear of material on the brake cheeks 5 is avoided. Even in case of greatly varying temperatures the operation of the brake is thus assured.

In FIG. 5, an additional embodiment of a catch brake according to the invention is represented schematically in a perspective view. Unlike the previous two FIGS. 3 and 4, in this embodiment the catch brake 1 is made as a multiple-component plastic object, preferably as an injection molding. For example, the back section 6 is made of a softer plastic material, such as a thermoplastic, for example, such as POM or the like. The brake cheeks 5 are in this embodiment made of a hard core, for example, a thermoset, which is enveloped by a softer, yet wear-resistant plastic such as a polyoxymethylene (POM), for example. In this manner, specific gripping actions can be produced by the brake cheeks 5 due to the shape and the composition of the different plastics, as for example a pincer-like, stronger gripping at the sides than in the middle area. The variability of the braking action and holding action of the catch brake is thus increased.

1-7. (canceled)

8. A catch brake for a trunk lid of a motor vehicle for slowing an opening movement of the trunk lid upon reaching its open position, the catch brake comprising:
a narrowing U-shaped clamping receiver for braking a tubular hinge bail of the trunk lid with a clamping action and to prevent the trunk lid from rebounding, the clamping receiver comprising
tapering lateral brake cheeks which form a continuous taper in the direction of the opening motion of the trunk lid, wherein the brake cheeks are elastically flexible to one another, and
a resiliently deformable connecting link joining the lateral brake cheeks together, wherein the resiliently deformable connecting link has a fastener for mounting the catch brake.

9. The catch brake according to claim 8, wherein the brake cheeks are so configured that the hinge bail can enter without head-on collision.

10. The catch brake according to claim 9, wherein the brake cheeks are formed from a hard plastic material that is resistant to attrition.

11. The catch brake according to claim 10, wherein the hard plastic material that includes polyoxymethylene.

12. The catch brake according to claim 11, wherein the connecting link is formed from a softer plastic than the lateral brake cheeks.

13. The catch brake according to claim 12, wherein the lateral brake cheeks are formed from a relatively hard core which is embedded in a softer plastic material.

14. The catch brake according to claim 8, wherein the brake cheeks are formed from a hard plastic material that is resistant to attrition.

15. The catch brake according to claim 14, wherein the hard plastic material that includes polyoxymethylene.

16. The catch brake according to claim 8, wherein the connecting link is formed from a softer plastic than the lateral brake cheeks.

17. The catch brake according to claim 16, wherein the lateral brake cheeks are formed from a relatively hard core which is embedded in a softer plastic material.

18. A trunk lid opening device of a motor vehicle for moving a trunk lid from a closed position to an open position, the opening device comprising:
a catch brake comprising:
a narrowing U-shaped clamping receiver for braking a tubular hinge bail of the trunk lid with a clamping action and to prevent the trunk lid from rebounding, the clamping receiver comprising
tapering lateral brake cheeks which form a continuous taper in the direction of the opening motion of the trunk lid, wherein the brake cheeks are elastically flexible to one another, and
a resiliently deformable connecting link joining the lateral brake cheeks together, wherein the resiliently deformable connecting link has a fastener for mounting the catch brake.

19. The trunk lid opening device according to claim 18, comprising an automatic system for opening the trunk lid.
